(19) United States
(12) Patent Application Publication
(10) Pub. No.: US 2026/0122259 A1
(43) Pub. Date: Apr. 30, 2026

(54) IMAGE PROCESSING METHOD AND APPARATUS THROUGH MULTI-TASK LEARNING, LEARNING METHOD FOR IMAGE PROCESSING

(71) Applicant: SAMSUNG ELECTRONICS CO., LTD., Suwon-si (KR)

(72) Inventors: Paul Oh, Suwon-si (KR); Seunghoon Jee, Suwon-si (KR); Dokwan Oh, Suwon-si (KR); Junhee Lee, Suwon-si (KR); Chansol Hwang, Suwon-si (KR)

(73) Assignee: SAMSUNG ELECTRONICS CO., LTD., Suwon-si (KR)

(21) Appl. No.: 19/067,170

(22) Filed: Feb. 28, 2025

(30) Foreign Application Priority Data
Oct. 25, 2024 (KR) 10-2024-0147475

(51) Int. Cl. H04N 19/42; H04N 19/137; H04N 19/463; H04N 19/60

(52) U.S. Cl. CPC H04N 19/42; H04N 19/137; H04N 19/463; H04N 19/60

(57) ABSTRACT

An image processing method, including: receiving an input image including a first image frame corresponding to a first time point and a second image frame corresponding to a second time point; inferring a plurality of parameters by applying the input image to a neural network model, wherein the plurality of parameters indicate global motion information including a three-dimensional (3D) motion of the input image and auxiliary information corresponding to at least one task using the global motion information; and outputting the plurality of parameters.

### CROSS-REFERENCE TO RELATED APPLICATION(S)

This application claims priority under 35 USC § 119 (a) to Korean Patent Application No. 10-2024-0147475, filed on Oct. 25, 2024, in the Korean Intellectual Property Office, the disclosure of which is incorporated by reference herein in its entirety.

### BACKGROUND

### 1. Field

The disclosure relates to an image processing method and apparatus through multi-task learning, and a learning method for image processing.

### 2. Description of Related Art

Artificial neural networks may be used for many tasks such as video compression (or, for example, video encoding) and video reconstruction (or, for example, video decoding). A neural codec may learn a feature of input data using a neural network, may compress and transmit the input data using encoding, and may decode and reconstruct the transmitted compression data.

With the development of information and communication technology and widespread use of mobile devices, images may be more diversely and actively captured, stored, and shared. As a result, it may be beneficial to use an image signal processing method for resolving physical degradation by processing a captured image, and a codec method for efficient storage and transmission. For video processing, both image signal processing and the use of a codec may improve the image quality by estimating a correlation between frames in an image sequence, or may store and transmit an image by compressing the correlation to a small volume.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In accordance with an aspect of the disclosure, an image processing method includes: receiving an input image including a first image frame corresponding to a first time point and a second image frame corresponding to a second time point; inferring a plurality of parameters by applying the input image to a neural network model, wherein the plurality of parameters indicate global motion information including a three-dimensional (3D) motion of the input image and auxiliary information corresponding to at least one task using the global motion information; and outputting the plurality of parameters.

The auxiliary information may include information about at least one of scene change detection, inter-frame prediction confidence, and skip decision.

The plurality of parameters may include a roll angle parameter, a pitch angle parameter, and a yaw angle parameter.

The plurality of parameters may include at least one of a translation parameter, a rotation parameter, a scale parameter, and a shear parameter.

The method may further include: generating a geometric transformation matrix by combining the plurality of parameters, wherein the geometric transformation matrix may include one of an affine transformation matrix and a homography transformation matrix.

The auxiliary information may be identified by an element number or an index of an output channel corresponding to each task of the at least one task.

The neural network model may be trained based on a first loss and a second loss, wherein the first loss is determined based on a first label and first global motion information inferred by applying the input image to the neural network model, and wherein the second loss is determined based on a second label and second auxiliary information inferred by applying, to the neural network model, an auxiliary image including a first auxiliary image frame corresponding to the first time point and a second auxiliary image frame corresponding to the second time point, and wherein the input image is extracted from a first database, and the auxiliary image is extracted from a second database.

The method may further include: generating an output image by encoding the first image frame and the second image frame using the plurality of parameters.

The output image may be generated by driving one of a codec, a video stabilizer, and an image signal processor (ISP) using the plurality of parameters.

In accordance with an aspect of the disclosure, a learning method includes: inferring a plurality of first parameters by applying an input image extracted from a first database to a neural network model, wherein the input image includes a first image frame corresponding to a first time point and a second image frame corresponding to a second time point, and wherein the plurality of first parameters include first global motion information and first auxiliary information corresponding to the input image; calculating a first loss based on the first global motion information and a first label associated with the plurality of first parameters; inferring a plurality of second parameters by applying, to the neural network model, an auxiliary image extracted from a second database, wherein the auxiliary image includes a first auxiliary image frame corresponding to the first time point and a second auxiliary image frame corresponding to the second time point, and wherein the plurality of second parameters include second global motion information and second auxiliary information; calculating a second loss based on a second label and the second auxiliary information; and training the neural network model based on the first loss and the second loss.

The inferring of the plurality of first parameters may include inferring a plurality of normalized first parameters that normalize the first global motion information in a predetermined range, and the calculating of the first loss may include: denormalizing the plurality of normalized first parameters; and calculating the first loss between the denormalized plurality of first parameters and a label corresponding to the first global motion information.

The first loss may include at least one of: a mean squared error (MSE) including an average value of a square of a difference between the first global motion information and the first label; and a mean absolute error (MAE) including an average value of a difference between the first global motion information and the first label.

The second loss may include a binary cross entropy (BCE) including a value that probabilistically indicates a proximity of the second auxiliary information to the second label.

The first label may include a soft label expressed by a probability between a value of zero (“0”) and a value of one (“1”), and the second label may include a hard label expressed as the value of zero (“0”) or the value of one (“1”).

The training of the neural network model based on the first loss and the second loss may include: training the neural network model by adjusting a reflection ratio between the first loss and the second loss.

In accordance with an aspect of the disclosure, a non-transitory computer-readable storage medium stores instructions that, when executed by a processor, cause the processor to: receive an input image including a first image frame corresponding to a first time point and a second image frame corresponding to a second time point; infer a plurality of parameters by applying the input image to a neural network model, wherein the plurality of parameters indicate global motion information including a three-dimensional (3D) motion of the input image and auxiliary information corresponding to at least one task using the global motion information; and output the plurality of parameters.

In accordance with an aspect of the disclosure, an image processing apparatus includes: an image sensor configured to capture an input image including a first image frame corresponding to a first time point and a second image frame corresponding to a second time point; a memory configured to store a neural network model; a processor configured to: infer a plurality of parameters by applying the input image to the neural network model, wherein the plurality of parameters indicate global motion information including a three-dimensional (3D) motion of the input image, and auxiliary information corresponding to at least one task using the global motion information, and generate a geometric transformation matrix by combining the plurality of parameters; and a communication interface configured to output the geometric transformation matrix.

The auxiliary information may include information about at least one of scene change detection, inter-frame prediction confidence, and skip mode decision.

The plurality of parameters may include at least one of: a roll angle parameter, a pitch angle parameter, and a yaw angle parameter, a translation parameter, a rotation parameter, a scale parameter, and a shear parameter.

The auxiliary information may be identified by an element number or an index of an output channel corresponding to each task of the at least one task.

Other features and aspects will be apparent from the following detailed description, the drawings, and the claims.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a flowchart of an image processing method according to an embodiment;

FIG. 2 is a diagram illustrating an image processing method according to an embodiment;

FIG. 3 is a flowchart of a learning method for image processing according to an embodiment;

FIGS. 4 to 6 are diagrams illustrating a learning method for image processing through multi-task learning according to embodiments;

FIG. 7A is a diagram illustrating a learning method of estimating global motion information according to an embodiment;

FIGS. 7B and 8 are diagrams illustrating a learning method of efficiently estimating global motion information according to an embodiment;

FIG. 9 is a diagram illustrating a configuration of an image processing apparatus according to an embodiment; and

FIG. 10 is a diagram illustrating an image processing apparatus.

### DETAILED DESCRIPTION

The following detailed structural or functional description is provided as an example only and various alterations and modifications may be made to the examples. Here, the examples are not construed as limited to the disclosure and should be understood to include all changes, equivalents, and replacements within the idea and the technical scope of the disclosure.

Throughout the drawings and the detailed description, unless otherwise described or provided, the same drawing reference numerals may generally refer to the same elements, features, and structures. The drawings may not be to scale, and the relative size, proportions, and depiction of elements in the drawings may be exaggerated for clarity, illustration, and convenience.

Terms, such as first, second, and the like, may be used herein to describe components. Each of these terms is not intended to define an essence, order or sequence of a corresponding component but used merely to distinguish the corresponding component from one or more other components. For example, a first component may be referred to as a second component, and similarly the second component may also be referred to as the first component.

It should be noted that if a first component is described as being “connected”, “coupled”, or “joined” to a second component, a third component may be “connected”, “coupled”, and “joined” between the first and second components, or the first component may be directly connected, coupled, or joined to the second component.

The singular forms “a”, “an”, and “the” are intended to include the plural forms as well, unless the context clearly indicates otherwise. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or populations thereof.

Unless otherwise defined, all terms used herein including technical or scientific terms have the same meaning as commonly understood by one of ordinary skill in the art to which examples belong. It will be further understood that terms, such as those defined in commonly-used dictionaries, should be interpreted as having a meaning that is consistent with their meaning in the context of the relevant art and will not be interpreted in an idealized or overly formal sense unless expressly so defined herein.

Hereinafter, embodiments are described in detail with reference to the accompanying drawings. When describing the embodiments with reference to the accompanying drawings, like reference numerals generally refer to like elements, and a redundant or duplicative description related thereto may be omitted.

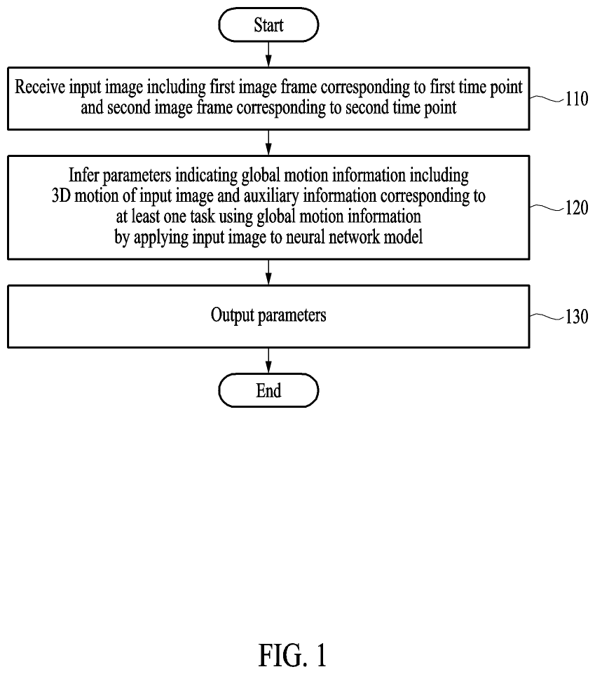

FIG. 1 is a flowchart of an image processing method according to an embodiment. Operations described hereinafter may be performed sequentially, but not necessarily performed sequentially. For example, the order of the operations may change and at least two of the operations may be performed in parallel.

Referring to FIG. 1, the image processing apparatus according to an embodiment may output parameters through operations 110 to 130.

At operation 110, the image processing apparatus may receive an input image including a first image frame corresponding to a first time point and a second image frame corresponding to a second time point. For example, the first image frame may be generated or captured at the first time point, and the second image frame may be generated or captured at the second time point. The first image frame may be referred to as a “current image frame” or a “source image frame”. The second image frame may be referred to as a “reference image frame” or a “target image frame”. The second time point may be prior to the first time point. The input image may be captured or generated by an image sensor or a camera.

At operation 120, the image processing apparatus may infer parameters by applying the input image received at operation 110 to a neural network model. The parameters may indicate global motion information including a three-dimensional (3D) motion of the input image and auxiliary information corresponding to at least one task using the global motion information.

The 3D motion of the input image may be expressed by one of a homography transformation matrix and an affine transformation matrix corresponding to the input image. When the 3D motion is expressed by the homography transformation matrix, the parameters may include, for example, a roll angle parameter, a pitch angle parameter, and a yaw angle parameter. In some embodiments, when the 3D motion is expressed by the affine transformation matrix, the parameters may include a translation parameter, a rotation parameter, a scale parameter, and/or a shear parameter.

Tasks that may reflect or relate to global characteristics (e.g., the global motion information) of an image may include, for example, global motion estimation by affine or homography transformation, affine advanced motion vector prediction (AMVP), scene change detection, inter-frame prediction confidence, and skip mode decision. However, the example is not limited thereto.

The affine AMVP may correspond to an advanced prediction technique used for video coding. The affine AMVP may be used for a versatile video coding (VVC) standard and may predict a motion through affine transformation. The affine transformation may model a complex motion, such as rotation, scaling, and shearing, in addition to simple 2D movement, and the affine transformation may therefore more accurately predict a motion and may improve compression efficiency.

Auxiliary information corresponding to at least one task may include at least one of scene change detection, inter-frame prediction confidence, and skip mode decision.

The scene change detection may correspond to detecting whether two image frames are captured in different scenes, or, for example, detecting whether a scene change occurs.

The inter-frame prediction confidence may correspond to an indicator showing the prediction accuracy of a current frame based on a previous frame. The inter-frame prediction may be performed using a technique such as motion compensation and block matching. As the prediction confidence increases, the compression efficiency may increase and the video quality may be maintained. However, as the prediction confidence decreases, the compression efficiency may decrease, and the video quality may be degraded. For example, when a correlation between two image frames is insufficient, inter-frame processing may be excluded by information that determines whether to perform inter-frame processing, such as estimation of global motion information, and only intra-frame processing (e.g., compression) may be performed.

The skip mode decision, which may also be referred as a skip decision, may correspond to skipping a specific image frame rather than encoding the specific image frame to increase the video compression efficiency. For example, when a difference between a previous image frame and a current image frame is insignificant, the skip decision may be used for increasing encoding speed and reducing a file size by using the previous image frame without encoding the current image frame or by reducing complexity during an encoding process.

The image processing apparatus may simultaneously infer motion estimation information and auxiliary information using one neural network model. The neural network model may minimize an additional chip area and power consumption and may improve compression and image stabilization functions by estimating the global motion information including the 3D motion while simultaneously outputting the auxiliary information that is completely different from the global motion information.

The neural network model may be a neural network trained by multi-task learning. The neural network model may include a deep neural network (DNN) including a plurality of layers. The plurality of layers may include an input layer, at least one hidden layer, and an output layer. The DNN may include at least one of a fully connected network (FCN), a convolutional neural network (CNN), and a recurrent neural network (RNN). For example, at least a portion of the plurality of layers in the neural network may correspond to a CNN, and another portion of the plurality of layers may correspond to an FCN. The portion corresponding to the CNN may be referred to as convolutional layers, and the portion corresponding to the FCN may be referred to as fully connected layers. In the case of the CNN, data input to each layer may be referred to as an input feature map, and data output from each layer may be referred to as an output feature map. The input feature map and the output feature map may also be referred to as activation data. When a convolutional layer corresponds to an input layer, an input feature map of the input layer may be, or may include, an image.

After being trained based on deep learning, a neural network model may map input data and output data that are in a linear relationship and/or a nonlinear relationship to perform an inference suitable for the purpose of training. Deep learning may refer to a machine learning technique for solving a problem such as image or speech recognition from a relatively large data set. Through supervised and/or unsupervised learning or training based on the deep learning, at least one of a structure of the neural network and a weight corresponding to a model may be obtained, and input data and output data may be mapped to each other based on the weight. When a width and depth of the neural network model are sufficiently large, the neural network may have sufficient capacity to implement a function. When the neural network model learns, or is trained on, a sufficiently large amount of training data through a suitable training process, optimal performance may be achieved.

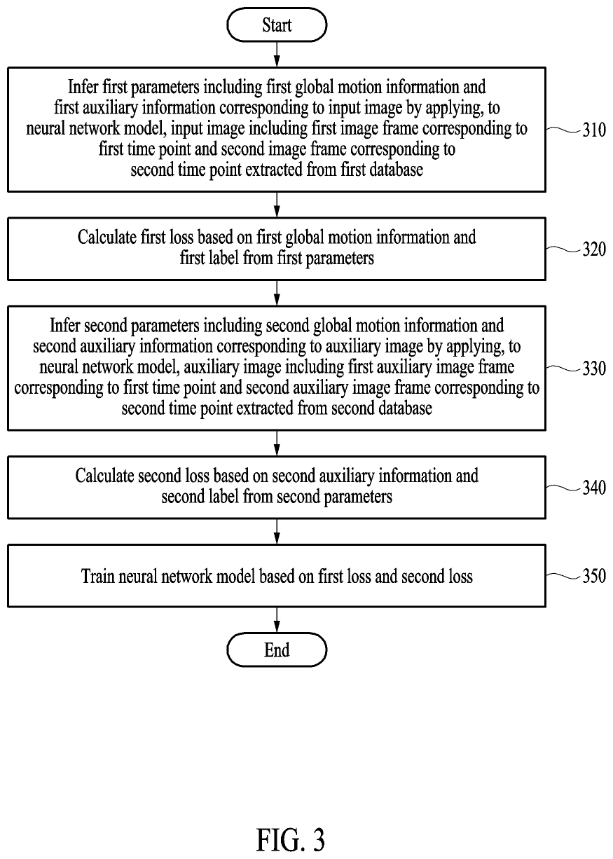

The neural network model may be trained based on a first loss between a first label and first global motion information inferred by applying, to the neural network model, an input image including a first image frame corresponding to a first time point and a second image frame corresponding to a second time point, wherein the first image frame and the second image frame are extracted from a first database, and a second loss between a second label and second auxiliary information inferred by applying, to the neural network model, an auxiliary image including a first auxiliary image frame corresponding to the first time point and a second auxiliary image frame corresponding to the second time point, wherein the first auxiliary image frame and the second auxiliary image frame are extracted from a second database. An example of a method of training the neural network model is further described with reference to FIGS. 3 to 8 below.

At operation 130, the image processing apparatus may output parameters inferred at operation 120. In this case, the auxiliary information (or, for example, a parameter corresponding to the auxiliary information) of the output parameters may be identified by an index or an element number of a corresponding output channel for each task. For example, when the output channel is formed by ten elements, sequentially, the global motion information may correspond to four elements and the auxiliary information may correspond to six elements. In this case, the auxiliary information may correspond to two elements corresponding to the scene change detection, two elements corresponding to inter-frame prediction confidence, and two elements corresponding to skip decision. As another example, when the output channel is formed by ten elements, sequentially, the global motion information may correspond to six elements and the auxiliary information may correspond to four elements. As described above, the type of auxiliary information may be determined by the element number or the index of the corresponding output channel for each task.

According to an embodiment, the image processing apparatus may generate a geometric transformation matrix by combining the parameters. The geometric transformation matrix may include one of an affine transformation matrix and a homography transformation matrix.

For example, based on the inferred parameters being a roll angle parameter, a pitch angle parameter, and a yaw angle parameter, the image processing device may generate a homography transformation matrix by combining the parameters. As another example, based on the inferred parameters including at least one of a translation matrix, a rotation parameter, a scale parameter, and a shear parameter, the image processing apparatus may generate the affine transformation matrix by combining the parameters.

According to an embodiment, the image processing apparatus may generate an output image by encoding the first image frame and the second image frame using the parameters output at operation 130. The image processing apparatus may generate the output image by driving one of a codec, a video stabilizer, and an image signal processor (ISP) using the parameters output at operation 130.

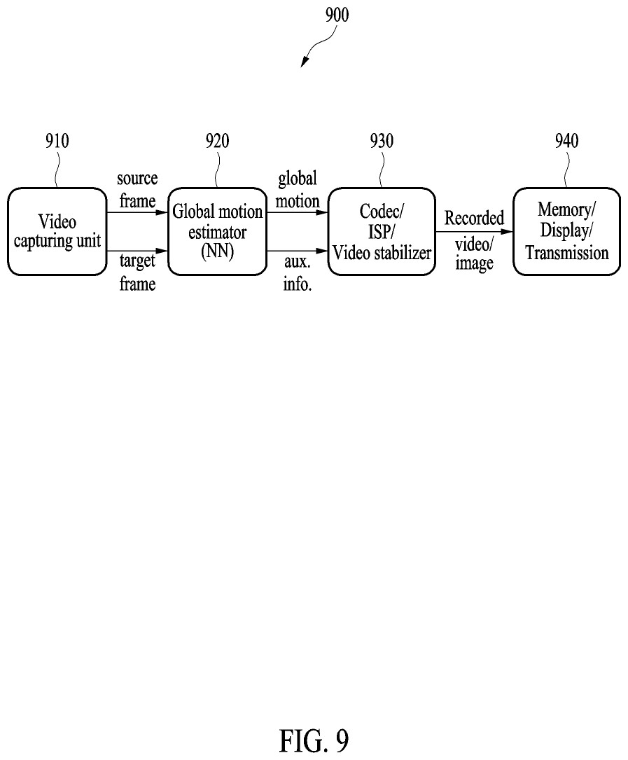

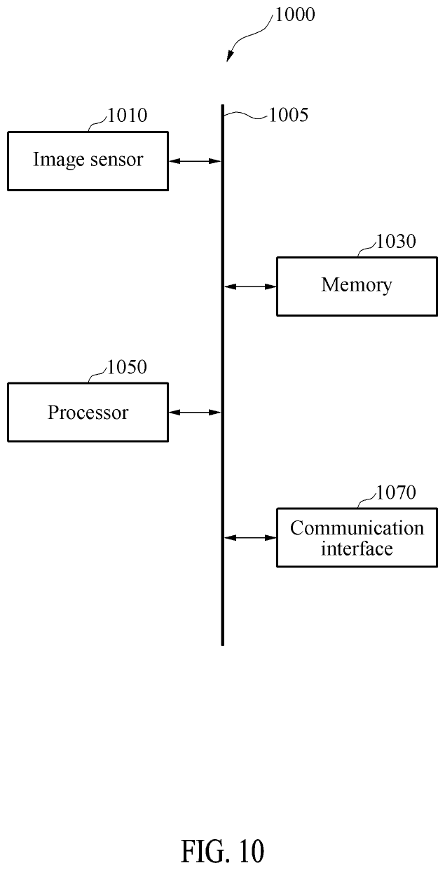

The image processing apparatus may be, for example, an image processing apparatus 900 of FIG. 9 and/or the image processing apparatus 1000 of FIG. 10, but embodiments are not limited thereto. The image processing apparatus may include a video codec device for performing encoding and/or decoding of a video and/or a neural codec. The neural codec may include a neural encoder. The neural encoder may be implemented in a mobile system on chip (SoC) including a neural processing unit (NPU). The neural encoder may be applied to various products for performing video compression. The neural encoder may convert a current input frame into a bitstream for video compression. The bitstream may be interpreted by a decoder of a target standard codec and may be reconstructed as an image. The target standard codec may include advanced video coding (AVC), high efficiency video coding (HEVC), versatile video coding (VVC), H.264/MPEG-4 AVC, AOMedia video 1 (AV1), video processor (VP) 9, and/or essential video coding (EVC). However, embodiments are not limited thereto.

The neural encoder may be implemented as a single framework supporting multiple codecs to process a video with high efficiency and provide scalability. The neural encoder may reduce the efforts and costs required to implement ASIC for the acceleration of an encoder in a typical standard video compression codec by operating a neural network compatible with a target decoder on an NPU mounted on a mobile SoC. The neural encoder may support accelerated encoding through an NPU without consuming a cost and an additional chip design for hardware acceleration.

The image processing apparatus may further include an apparatus for processing the physical degradation of an image, such as image stabilizer, noise reduction, high dynamic range (HDR), de-blur, and frame rate up conversion.

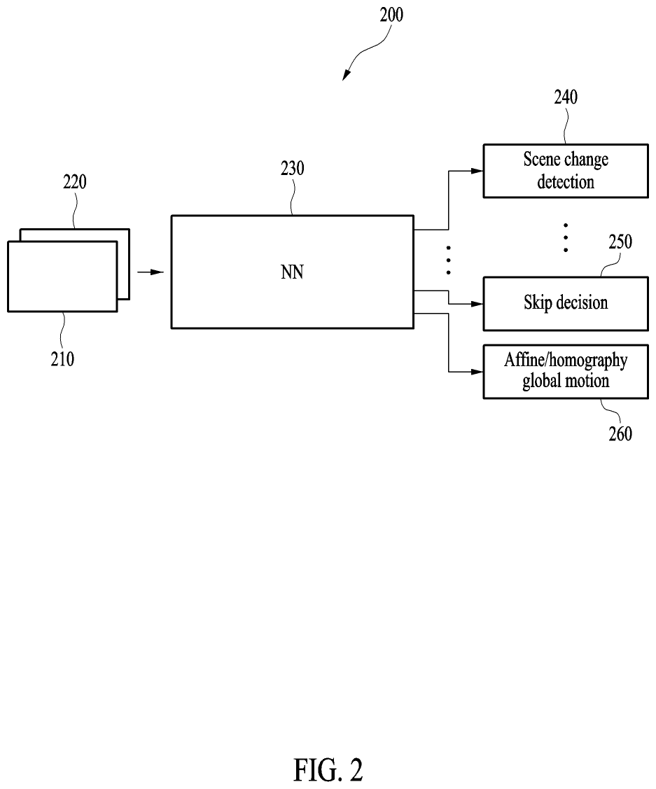

FIG. 2 is a diagram illustrating an image processing method according to an embodiment. As illustrated in FIG. 2, according to a process 200, a neural network model 230 may output parameters indicating global motion information 260 by affine and/or homography transformation, and may also output auxiliary information, such as scene change detection information 240 and skip decision information 250, based on a first image frame 210 and a second image frame 220 being applied to the neural network model 230, according to an embodiment.

The first image frame 210 may be generated at (e.g., may correspond to) a first time point and the second image frame 220 may be generated at (e.g., may correspond to) a second time point.

The neural network model 230 may be a neural network trained by multi-task learning. The neural network model 230 may infer parameters indicating the global motion information including a 3D motion of an input image (e.g., the first image frame 210 and the second image frame 220) and the auxiliary information corresponding to at least one task using the global motion information.

The neural network model 230 may be trained based on a first loss between a first label and first global motion information inferred by applying, to the neural network model, an input image including the first image frame 210 corresponding to the first time point and the second image frame 220 corresponding to the second time point, wherein the first image frame 210 and the second image frame 220 are extracted from a global motion database (e.g., the first database) and a second loss between a second label and second auxiliary information inferred from an auxiliary image including a first auxiliary image frame corresponding to the first time point and a second auxiliary image frame corresponding to the second time point, wherein the first auxiliary image frame and the second auxiliary image frame are extracted from an auxiliary information database (e.g., the second database). An example method for training the neural network model 230 is further described with reference to FIGS. 3 to 8 below.

Because estimating or predicting the global motion information 260 and the auxiliary information (e.g., the scene change detection information 240 and the skip decision information 250) may be tasks having completely different characteristics, it may be difficult to construct a single training database for training both tasks, and instead, a database for inferring the global motion information (e.g., the first database) and a separate database for identifying the auxiliary information such as scene change (e.g., the second database) may be used.

For example, a task for estimating the global motion information 260 may aim to estimate a global motion (GM) label including a 3D motion between two consecutive image frames (e.g., the first image frame 210 and the second image frame 220), which may be or may include, for example, a global motion parameter or a global motion matrix. Therefore, a significant GM label may not be obtained from two image frames selected from different scenes that are non-consecutive.

Image sets included in the global motion database according to an embodiment may include two image frames (e.g., the first image frame 210 and the second image frame 220) selected from the same scene and a GM label (e.g., a first label) corresponding to the two image frames.

However, in the case of auxiliary information, such as a scene change detection task, a signal indicating that a scene change occurs in two images selected from different scenes may need to be output. Therefore, the database (e.g., the second database) for the auxiliary information such as scene change detection may include two image sets selected from the same scene and two image sets selected from different scenes and may also include a binary label on the occurrence of a scene change. Therefore, to perform two tasks by one neural network model, for example the neural network model 230, typical multi-label learning may not be applied.

In addition, when modules respectively processing global motion information estimation and scene change detection operate separately, buffers and operators as large as the size of each image frame may be required, and therefore, the possibility of an increase in power and/or a chip area and the possibility of repeating a similar task during a process of inferring required information from image data may exist. In addition, in a vision-based scheme, integrating tasks into one may not be easy because the tasks may have different domains.

The neural network model 230 according to an embodiment may infer the auxiliary information, such as the scene change detection information 240, in addition to the global motion information 260 including a 3D motion of an object in the input image. The neural network model 230 may additionally connect layers (e.g., a relatively small number of layers) for inferring the auxiliary information (e.g., the scene change detection information 240 and the skip decision information 250) to a backbone of a network for inferring the global motion information 260 to infer the global motion information 260 while simultaneously inferring the auxiliary information without significantly increasing a parameter of the network or significantly modifying a network for estimating the global motion information.

Among the parameters output by the neural network model 230, locations of the parameters respectively corresponding to the global motion information 260 and the auxiliary information (e.g., the scene change detection information 240 and the skip decision information 250) may be identified by an element number or an index of an output channel corresponding to each task.

For tasks related to global characteristics (e.g., the global motion information 260) between the first and second image frames 210 and 220, the neural network model 230 may be a multi-task network (e.g., a multi-task neural network model) that may infer different tasks by receiving a pair of image frames from one neural network. According to an embodiment, performance improvement and reduced encoding time may be expected by inferring optimized auxiliary information in the neural network model 230. Furthermore, when an image processing apparatus corresponding to the process 200 (e.g., an image processing apparatus which includes or implements the neural network model 230) is implemented as hardware, a reduction in a chip area and/or a reduction in power may be expected.

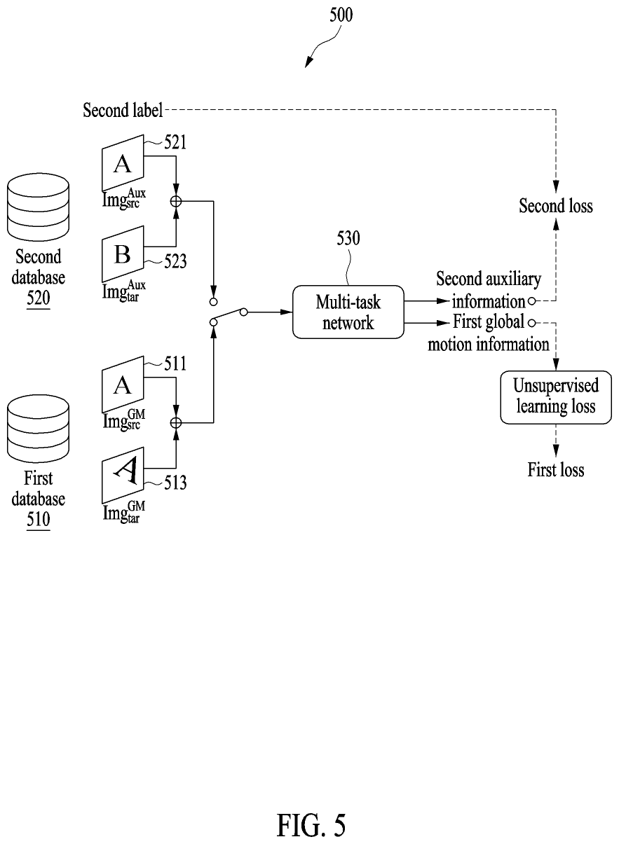

FIG. 3 is a flowchart of a learning method (which may also be referred to as a training method) for image processing according to an embodiment. Referring to FIG. 5, a learning device according to an embodiment may learn or train a neural network model through operations 310 to 350.

At operation 310, the learning device may infer first parameters by applying, to the neural network model, an input image including a first image frame corresponding to a first time point and a second image frame corresponding to a second time point, wherein the first image frame and the second image frame are extracted from a first database. The first parameters may include first global motion information and first auxiliary information corresponding to the input image. The learning device may infer the first parameters that normalize the first global motion information within a predetermined range.

At operation 320, the learning device may calculate a first loss between or based on the first global motion information and a first label from the first parameters inferred at operation 310. The first loss may include one of a mean squared error (MSE), which may be an average value of a squared difference between the first global motion information and the first label, and a mean absolute error (MAE), which may be an average value of an absolute value of a difference between the first global motion information and the first label. However, embodiments are not limited thereto. The first label may be a soft label expressed by a probability between a value of zero (“0”) and a value of one (“1”).

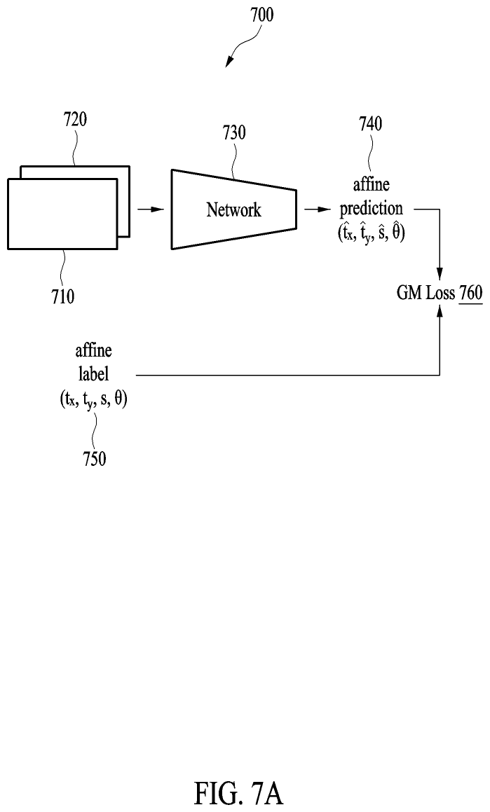

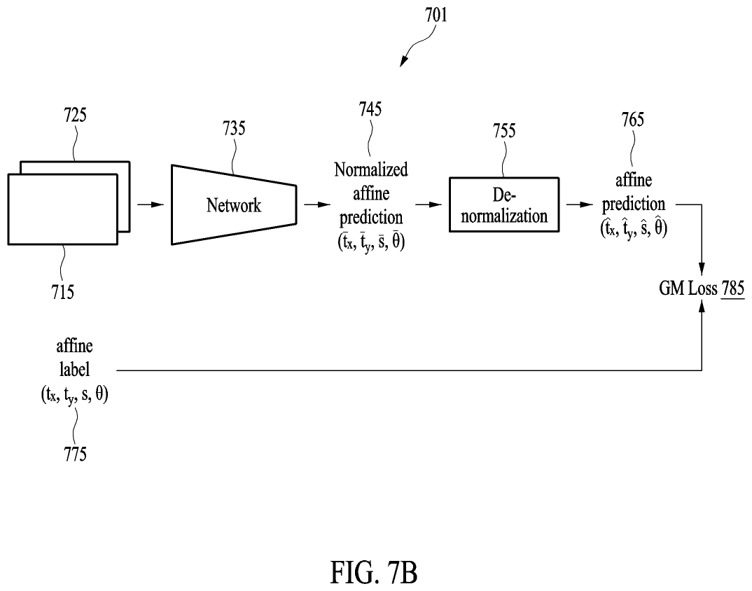

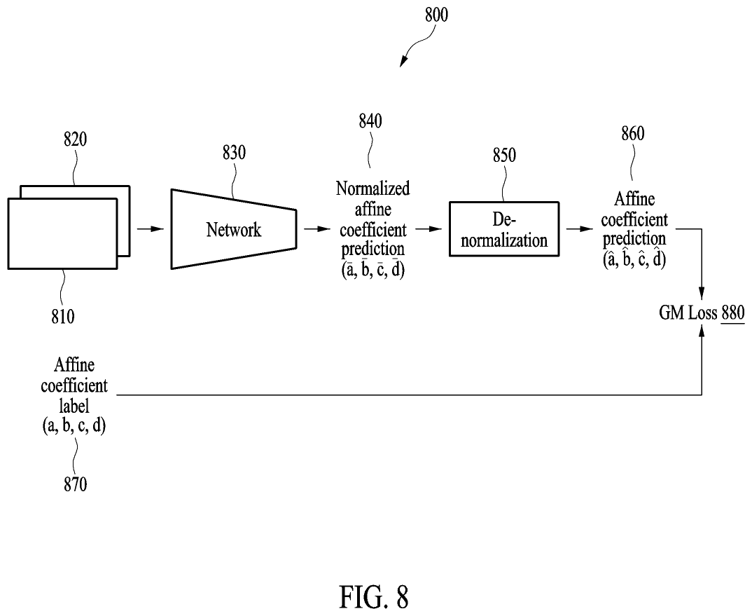

When the learning device infers the normalized first parameters at operation 310, then at operation 320, the learning device may denormalize the normalized first parameters and may calculate the first loss between or based on the denormalized first parameters and a label corresponding to the first global motion information. An example of a method of efficiently estimating the global motion information through normalization is further described with reference to FIGS. 7B and 8.

At operation 330, the learning device may infer second parameters including second global motion information and second auxiliary information corresponding to an auxiliary image including a first auxiliary image frame corresponding to the first time point and a second auxiliary image frame corresponding to the second time point, wherein the first auxiliary image frame and the second auxiliary image frame are extracted from a second database, by applying the auxiliary image to the neural network model.

At operation 340, the learning device may calculate a second loss between or based on the second auxiliary information and a second label from the second parameters inferred at operation 330. The second loss may include a binary cross entropy (BCE), which is a value that probabilistically indicates how close the second auxiliary information is to the second label. However, the example is not limited thereto. The second label may be a hard label expressed by a value of zero (“0”) or a value of one (“1”).

At operation 350, the learning device may learn or train the neural network model based on the first loss calculated at operation 320 and the second loss calculated at operation 340. The learning device may learn or train the neural network model by adjusting a reflection ratio between the first loss and the second loss. The learning device may adjust the reflection ratio by weights respectively corresponding to the first loss and the second loss or a weight corresponding to one loss (the first loss or the second loss).

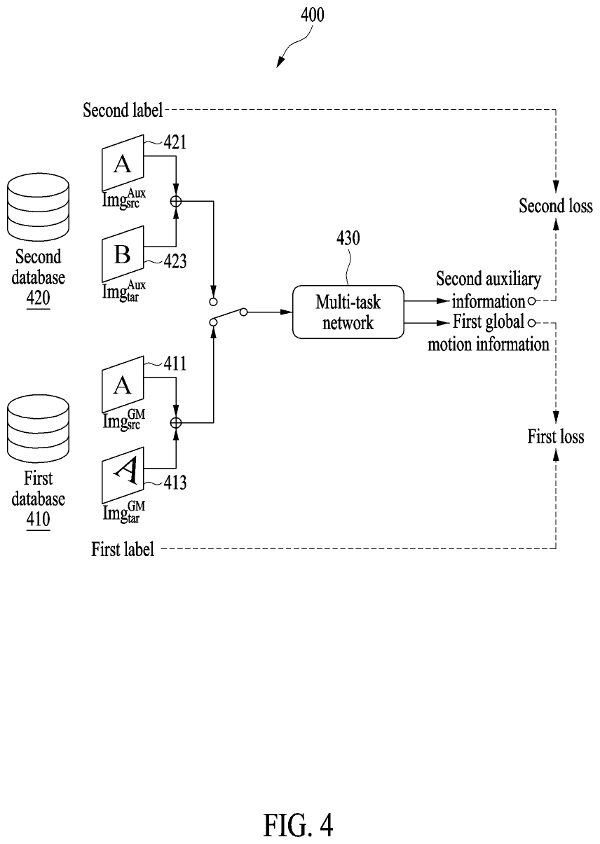

FIG. 4 is a diagram illustrating a learning method for image processing through multi-task learning according to an embodiment. Referring to FIG. 4, a training environment 400 corresponding to a learning process of a multi-task network that infers parameters including auxiliary information and global motion information including a 3D motion according to an embodiment is shown.

The learning device may apply, to the neural network model 430, two images (e.g., a first image frame 411 and a second image frame 413) extracted or sampled from a first database 410 to infer first global motion information (GM prediction), which may be or may include, for example, generating predicted first global motion information. In this case, in a neural network model 430, first parameters including the first global motion information and first auxiliary information may be output. However, the learning device may calculate a first loss using only the first global motion information among the first parameters. The first database 410 may store an image set (e.g., an image frame pair and a first label) related to the global motion information.

The learning device may calculate a first loss based on a difference between the first global motion information (e.g., a GM prediction) and the first label (e.g., a GM label). For example, the learning device may calculate the first loss based on an MSE or MAE loss function according to Equation 1 shown below. The first loss may be referred to as a “GM loss” and may be denoted L_{GM} since the first loss corresponds to the global motion information. The first label may be a soft label expressed by the probability between a value of zero (“0”) and a value of one (“1”).

$${L}_{GM} = F ( GM label , GM prediction ) , \qquad [ Equation 1 ]$$

$$F ∈ \{ MSE , MAE \}$$

After calculating the first loss, the learning device may output second parameters including second global motion information and second auxiliary information by applying, to the neural network model 430, two image frames (e.g., a first auxiliary image frame 421 and a second auxiliary image frame 423) extracted or sampled from a second database 420.

The second database 420 may include, for example, an image set (e.g., a pair of image frames and a second label) related to scene change detection. In this case, second parameters including the second global motion information and the second auxiliary information may be output from the neural network model 430, but the learning device may calculate a second loss using only the second auxiliary information among the second parameters.

The learning device may calculate the second loss based on a difference between the second auxiliary information (Aux.info.prediction) and the second label (Aux.info.label) according to Equation 2 shown below. For example, the learning device may calculate the second loss based on a BCE loss function according to Equation 2 shown below. The second loss may be referred to as an “aux loss” and may be denoted L_{AUX} because the second loss may correspond to the auxiliary information. The second label may be a hard label expressed by a value of zero (“0”) or a value of one (“1”)1.

$${L}_{Aux} = BCE ( \begin{matrix}Aux \cdot info \cdot label , \\ Aux \cdot info \cdot prediction\end{matrix} ) \qquad [ Equation 2 ]$$

The learning device may obtain a total loss, which may be denoted Lₜₒₜ, by calculating the first loss (e.g., L_{GM}) and the second loss (e.g., L_{Aux}) in each training step from each database (e.g., the first database 410 and the second database 420) according to Equation 3 shown below.

$${L}_{tot} = {L}_{GM} + λ {L}_{Aux} \qquad [ Equation 3 ]$$

In Equation 3 above, λ may denote a parameter (e.g., a “weight”) that adjusts the reflection ratio between the first loss and the second loss and may typically have a positive value less than one (“1”).

FIG. 5 is a diagram illustrating a learning method for image processing through multi-task learning according to an embodiment. Referring to FIG. 5, a training environment 500 corresponding to a process in which a learning device learns a multi-task network in an environment without a first label corresponding to global motion information according to an embodiment is shown.

In an embodiment, the global motion information and other tasks may share global information such that hidden layers and features in a network are shared, and thereby, results may be simultaneously obtained.

A neural network model 530 may be trained according to unsupervised learning using backpropagation. The neural network model 530 may include a differentiable prediction (DP) module which may be differentiably implemented to flow backpropagation. The neural network model 530 may be trained by unsupervised learning using backpropagation using the DP module.

For example, the learning device may infer first global motion information by applying two images (e.g., a first image frame 511 and a second image frame 513) stored in a first database 510 to the neural network model 530. In this case, although the first global motion information and the first auxiliary information may be output from the neural network model 530, the learning device may calculate a first loss according to unsupervised learning using only the first global motion information.

When the learning device uses the DP module, Equation 1 for obtaining the first loss may be changed to Equation 4 below.

$${L}_{GM} = F ( {Img}_{tar}^{GM} , I {g}_{tar}^{GM} ) , F ∈ \{ MSE , MAE \} \qquad [ Equation 4 ]$$

In Equation 4 above,

$${Img}_{tar}^{GM}$$

may be denote the second image frame 513 (e.g., a target image frame). In addition,

$${tar}_{GM}^{}$$

may be an image frame obtained by transforming (e.g., affine transformation or homography transformation) the first image frame 511 (e.g., a source image frame) by the DP module using first information estimated by the neural network model 530.

The learning device may calculate the first loss according to unsupervised learning by calculating an MSE or an MAE between the two image frames (e.g., between

$${Img}_{tar}^{GM} and {tar}_{GM}^{} ) .$$

After calculating the first loss, the learning device may output second global motion information and auxiliary information by applying, to the neural network model 530, two image frames (e.g., a first auxiliary image frame 521 and a second auxiliary image frame 523) from a second database 520. In this case, the second global motion information and the second auxiliary information may be output from the neural network model 530, but the learning device may calculate a second loss (e.g., L_{Aux}) using only the second auxiliary information.

The learning device may calculate the second loss based on the BCE loss function between the second auxiliary information (Aux.info.prediction) and the second label (Aux.info.label) according to Equation 2 described above.

The learning device may obtain the total loss (e.g., Lₜₒₜ) by calculating the first loss (e.g., L_{GM}) and the second loss (e.g., L_{Aux}) in each training step from each database according to Equation 3 described above.

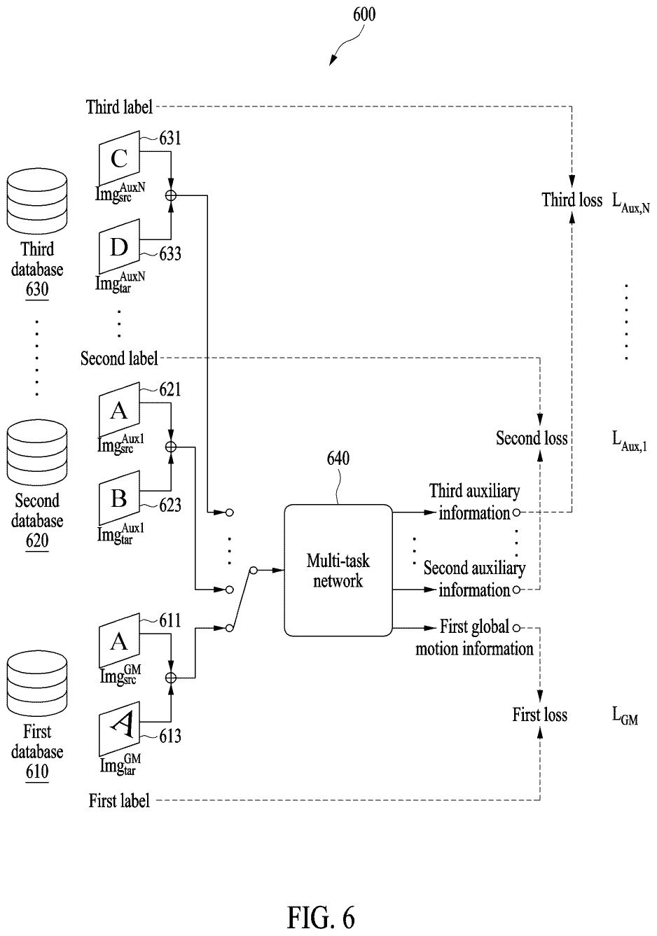

FIG. 6 is a diagram illustrating a learning method for image processing through multi-task learning according to an embodiment. Unlike the training environment 400 of FIG. 4, in which one piece of auxiliary information (e.g., scene change detection) is learned with the global motion information, in the training environment 600 of FIG. 6, the learning device may perform multi-task learning with the global motion information using two pieces of auxiliary information (e.g., scene change detection information and inter-frame prediction confidence information) as hard label information.

The learning device may infer first global motion information by applying, to a neural network model 640, two images (e.g., a first-first image frame 611 and first-second image frame 613) extracted from a first database 610. In embodiments, the first-first image frame 611 may correspond to a first image frame discussed above, and the first-second image frame 613 may correspond to a second image frame discussed above. The first database 610 may store an image set (e.g., an image frame pair and a first label) related to the global motion information. In this case, the neural network model 640 may output first parameters including first global motion information and first auxiliary information, but the learning device may calculate a first loss using the first global motion information (or parameters corresponding to the first global motion information) among the first parameters.

For example, the learning device may calculate the first loss (e.g., L_{GM}) based on the difference between the first global motion information (e.g., a GM prediction) and the first label (e.g., a GM label) according Equation 1 described above. The first label may be a soft label expressed by the probability between a value of zero (“0”) and a value of one (“1”).

After calculating the first loss, the learning device may output second parameters including second global motion information and second auxiliary information by extracting two image frames (e.g., a second-first auxiliary image frame 621 and a second-second auxiliary image frame 623) from a second database 620 and applying the two image frames to the neural network model 640. The second database 620 may include, for example, an image set (e.g., pairs of image frames and second labels) related to scene change detection. In this case, the neural network model 640 may output second parameters including the second global motion information and the second auxiliary information, but the learning device may calculate the second loss using only the second auxiliary information (or parameters corresponding to the second auxiliary information) among the second parameters.

The learning device may calculate the second loss, which may be denoted L_{Aux,1}, based on the BCE loss function between the second auxiliary information (Aux.info.prediction) and the second label (Aux.info.label) according to Equation 2 described above. The second label may be a hard label expressed by a value of zero (“0”) or a value of one (“1”).

After calculating the second loss, the learning device may output third parameters including third global motion information and third auxiliary information by extracting two image frames (e.g., a third-first auxiliary image frame 631 and a third-second auxiliary image frame 633) from a third database 630 and applying the two image frames to the neural network model 640. The third database 630 may include, for example, an image set (e.g., a pair of image frames and a third label) related to inter-frame prediction confidence. In this case, the neural network model 640 outputs the third parameters including the third global motion information and the third auxiliary information, but the learning device may calculate a third loss using only the third auxiliary information (or the third parameters corresponding to the third auxiliary information).

The learning device may calculate a third loss, which may be denoted L_{Aux,N}, based on the BCE loss function between the third auxiliary information (Aux.info.prediction) and the third label (Aux.info.label) according to Equation 2 described above. The third label may be a hard label expressed by a value of zero (“0”) or a value of one (“1”).

The learning device may obtain the total loss (e.g., Lot) by calculating the first loss (e.g., L_{GM}), the second loss (e.g., L_{Aux,1}), and the third loss (e.g., L_{Aux,N}) in each training step from each database (e.g., the first database 610, the second database 620, and the third database 630) according to Equation 5 below.

$${L}_{tot} = {L}_{GM} + {\sum }_{n = 1}^{N} {λ}_{n} {L}_{Aux , n} \qquad [ Equation 5 ]$$

In Equation 5 above, λₙ may denote a parameter (a “weight”) that adjusts a reflection ratio among the first loss corresponding to the global motion information, the second loss, and the third loss corresponding to the auxiliary information and may typically have a positive value less than one (“1”). In this case, the weight λₙ applied to each loss may vary.

FIG. 7A is a diagram illustrating a learning method of estimating global motion information according to an embodiment. Referring to FIG. 7A, a training environment 700 illustrating a process in which a learning device learns or trains a neural network model 730 with global motion information (e.g., an affine transformation matrix) according to an embodiment is shown.

The neural network model 730 may perform regression on specific parameters by receiving a pair of image frames (e.g., a first image frame 710 and a second image frame 720). In this case, the specific parameter may correspond to an element of the affine transformation matrix (or the homography transformation matrix) or may be in the form of a domain (e.g., a coefficient) that may be relatively easy to analyze.

When using the affine transformation matrix as the global motion information as shown in FIG. 7A, the neural network model 730 may infer a translation parameter \hat{t}ₓ, \hat{t}_{y} in x and y directions, a rotation parameter \hat{θ}, a scale parameter Ŝ, and/or a shear parameter for using in a codec. In this case, the translation parameter may be inferred as a ratio in the image or may be inferred pixel-wise. The rotation parameter may be inferred as a radian, a degree, or a ratio in a determined range. The scale parameter may be inferred as a scale factor of zoom in or zoom out.

The learning device may learn or train the neural network model 730 based on a first loss 760 (e.g., a GM loss) based on a difference between parameters 740 of the affine transformation matrix (e.g., the parameters \hat{t}ₓ, \hat{t}_{y}, Ŝ, \hat{θ} illustrated in FIG. 7A) inferred by the neural network model 730 and affine labels 750 (e.g., the labels tₓ, t_{y}, S, θ illustrated in FIG. 7A).

According to an embodiment, when using the homography transformation matrix as the global motion information, the neural network model 730 may infer rotation angles of x, y, and z, which may be or may include, for example, a roll angle parameter, a pitch angle parameter, and a yaw angle parameter for using in a video stabilizer. In this case, the rotation angle may be inferred as a radian, a degree, or a ratio in a determined range.

FIG. 7B is a diagram illustrating a learning method of efficiently estimating global motion information according to an embodiment. Referring to FIG. 7B, a training environment 701 corresponding to a process in which the learning device learns an affine transformation matrix, which is a type of global motion information, is shown.

When the learning device may simultaneously learn global motion information and auxiliary information, ranges of values of parameters (e.g., a translation parameter, a rotation parameter, a scale parameter, and/or a shear parameter) corresponding to the global motion information (e.g., the affine transformation matrix) may vary. When the ranges of values of the parameters vary, the learning speed may be slow and a lightweight network may not learn some parameters corresponding to the global motion information.

In an embodiment, a neural network model 735 may infer (or estimate) first parameters normalized in a predetermined range (e.g., between a value of negative one (“−1”) and positive one (“+1”)) rather than directly inferring global motion information (e.g., the first parameters) having different ranges for effective learning on the global motion information. For example, the neural network model 735 may not directly infer the first parameters having different ranges but may estimate the first parameters normalized in a predetermined range (e.g., between a value of negative one (“−1”) and positive one (“+1”)) and may denormalize the first parameters to correct the first parameters in an actual scale to use.

The method of learning the neural network model 735 for inferring the normalized first parameters by the learning device is as follows.

The learning device may estimate parameters 745 of a normalized affine transformation matrix (e.g., the parameters t̅ₓ, t̅_{y}, θ̅, S̅ illustrated in FIG. 7B) by applying, to the neural network model 735, two images (e.g., a first image frame 715 and a second image frame 725) extracted from a database (e.g., the first database). The parameters 745 of the normalized affine transformation matrix may include translation parameters t̅ₓ and t̅_{y} in the x and y directions, a rotation parameter θ̅ in the z direction, and a scale parameter S̅.

The learning device may transform the parameters 745 of the normalized affine transformation matrix output from the neural network model 735 to parameters 765 of an actual affine transformation matrix (e.g., the parameters \hat{t}ₓ, \hat{t}_{y}, Ŝ, \hat{θ} illustrated in FIG. 7B) by performing a denormalization 755 on the parameters according to Equation 6 below.

$${\hat{t}}_{x} = {k}_{x} \cdot {\overline{t}}_{x} \qquad [ Equation 6 ]$$

$${\hat{t}}_{y} = {k}_{y} \cdot {\overline{t}}_{y}$$

$$\hat{s} = 1 + {k}_{s} \cdot \overline{s}$$

$$\hat{θ} = {k}_{θ} \cdot \overline{θ}$$

In Equation 6 above, Kₓ, K_{y}, Kₛ, and k_{θ} may denote values for denormalization and may be set in advance during learning. For example, kₓ and k_{y} may be set to 64 (pixels). kₛ may be set to 0.5. k_{θ} may be set to 20 (degrees).

The parameters 765 of the affine transformation matrix may include a parameter corresponding to auxiliary information. The auxiliary information included in the affine transformation matrix may output a probability value of true or false based on a threshold set to each auxiliary information.

The learning device may learn or train the neural network model 735 based on a first loss 780 (e.g., a GM loss) based on a difference between the parameters 765 (e.g., the parameters \hat{t}ₓ, \hat{t}_{y}, Ŝ, \hat{θ}) of the affine transformation matrix and affine labels 775 (e.g., the labels tₓ, t_{y}, S, θ).

According to embodiments, the learning device may learn a homography transformation matrix, which is a type of the global motion information. When the learning device learns the homography transformation matrix, the neural network model 735 may output parameters of the normalized homography transformation matrix (e.g., parameters t̅ₓ, t̅_{y}, θ₁, θ₂, θ₃) instead of the parameters 745 of the normalized affine transformation matrix (e.g., the parameters t̅ₓ, t̅_{y}, θ̅, S̅ illustrated in FIG. 7B).

A homography transformation matrix H for video stabilization may be defined according to Equation 7 below.

$$H = [ \begin{matrix}cos {θ}_{1} cos {θ}_{2} & cos {θ}_{1} sin {θ}_{2} sin {θ}_{3} - & cos {θ}_{1} sin {θ}_{2} cos {θ}_{3} + \\ & sin {θ}_{1} cos {θ}_{3} & sin {θ}_{1} sin {θ}_{3} \\ sin {θ}_{1} cos {θ}_{2} & sin {θ}_{1} sin {θ}_{2} sin {θ}_{3} + & sin {θ}_{1} sin {θ}_{2} cos {θ}_{3} - \\ & cos {θ}_{1} cos {θ}_{3} & cos {θ}_{1} sin {θ}_{3} \\ - sin {θ}_{2} & cos {θ}_{2} sin {θ}_{3} & cos {θ}_{2} cos {θ}_{3}\end{matrix} ] \qquad [ Equation 7 ]$$

As shown in Equation 7, the homography transformation matrix H may be formed by estimating only θ₁, θ₂, θ₃ without translation elements tₓ and t_{y}. In this case, a value for denormalization may be set to 20 degrees.

FIG. 8 is a diagram illustrating a learning method of efficiently estimating global motion information according to an embodiment. Referring to FIG. 8, according to a training environment 800, a learning device according to an embodiment may infer a coefficient of an affine transformation matrix instead of parameters of the affine transformation matrix. The learning device may remove a non-linear function, such as a sine function and/or a cosine function, which may occur when transforming actual parameters to the affine transformation matrix.

The learning device may estimate coefficients 840 of a normalized affine transformation matrix (e.g., the coefficients ā, b̅, c̅, d̅ illustrated in FIG. 8) by applying, to a neural network model 830, two images (e.g., a first image frame 810 and a second image frame 820) extracted from a database (e.g., the first database).

In this case, the coefficients 840 of the normalized affine transformation matrix may have a correspondence relationship as shown in Equation 8 below.

$$A = [ \begin{matrix}a & - b & \frac{1 - a}{2} W + \frac{b}{2} H + c \\ b & a & \frac{1 - a}{2} H - \frac{b}{2} W + d \\ 0 & 0 & 1\end{matrix} ] = [ \begin{matrix}s \cdot cos θ & - s \cdot sin θ & \frac{1 - s \cdot cos θ}{2} W + \frac{sin θ}{2} H + s \cdot {t}_{x} \\ s \cdot sin θ & s \cdot cos θ & \frac{1 - s \cdot cos θ}{2} H - \frac{sin θ}{2} W + s \cdot {t}_{y} \\ 0 & 0 & 1\end{matrix} ] \qquad [ Equation 8 ]$$

In Equation 8 above, W may denote a number of horizontal pixels of an image, and H may denote a number of vertical pixels of the image.

The learning device may improve the inference speed of the neural network model 830 by simplifying an operation by using values

$$( e . g . , a , - b , \frac{1 - a}{2} W + \frac{b}{2} H + c , and \frac{1 - a}{2} H - \frac{b}{2} W + d )$$

after sine and cosine operations in the rightmost side of Equation 8 are performed.

The learning device may transform the coefficients 840 of a normalized affine transformation matrix A output from the neural network model 830 to coefficients 860 of an actual affine transformation matrix A (e.g., the coefficients \hat{t}ₓ, \hat{t}_{y}, Ŝ, \hat{θ} illustrated in FIG. 8) by performing a denormalization 850 on the coefficients, for example according to Equation 9 below.

$$\hat{a} = 1 + {k}_{a} \cdot \overline{a} \qquad [ Equation 9 ]$$

$$\hat{b} = {k}_{b} \cdot \overline{b}$$

$$\hat{c} = {k}_{c} \cdot \overline{c}$$

$$\hat{d} = {k}_{d} \cdot \overline{d}$$

In Equation 9 above, kₐ, k_{b}, k_{c}, and k_{d} may note parameters for denormalizing the coefficients of the normalized affine transformation matrix and may be set in advance during learning.

The coefficients 860 of the actual affine transformation matrix A (e.g., the coefficients â, \hat{b}, ĉ, \hat{d} illustrated in FIG. 8) may also include a coefficient of a parameter corresponding to the auxiliary information. The auxiliary information included in the coefficient 860 of the actual affine transformation matrix A may output a probability value of true or false based on a threshold set to each auxiliary information.

The learning device may learn or train the neural network model 830 by a first loss 880 (e.g., a GM loss) based on a difference between the coefficients 860 of the actual affine transformation matrix (e.g., the coefficients â, \hat{b}, ĉ, \hat{d}, and the affine coefficient labels 870 (e.g., the coefficient labels a, b, c, d illustrated in FIG. 8).

FIG. 9 is a diagram illustrating a configuration of an image processing apparatus according to an embodiment.

As shown in FIG. 9, an image processing apparatus 900 may infer parameters including global motion information and auxiliary information using a neural network model 920 trained by multi-task learning based on two image frames (e.g., a source frame and a target frame) obtained from a camera and/or video capture by a video capturing unit 910. The neural network model 920 may be referred to as a “global motion estimator” because the neural network model 920 may estimate a global motion.

The image processing apparatus 900 may use the parameters inferred by the neural network model 920 as elements (e.g., parameters) of an affine transformation matrix or a homography transformation matrix for a codec (e.g., AV1 or VVC), an ISP, and/or a video stabilizer 930.

According to embodiments, the neural network model 920 may be separated from the codec, the ISP, and/or the video stabilizer 930 as shown in FIG. 9, or may include the codec, the ISP, and/or the video stabilizer 930.

The image processing apparatus 900 may use auxiliary information (e.g., scene change detection) that may be estimated together with the global motion information as information for determining whether to perform inter-frame processing in advance. For compression using the auxiliary information, the image processing apparatus 900 may perform optimized encoding, such as excluding inter-frame processing and performing only the intra-frame processing, to obtain benefits in terms of power consumption and speed. In addition, the image processing apparatus 900 may assist the video stabilizer with inferring a natural motion using the auxiliary information.

The image processing apparatus 900 may output an output image and/or a video image generated through the codec, the ISP, and/or the video stabilizer 930 to a memory, a display, and/or an outside 940 of the image processing apparatus 900.

FIG. 10 is a diagram illustrating an image processing apparatus. Referring to FIG. 10, an image processing apparatus 1000 according to an embodiment may include an image sensor 1010, a memory 1030, a processor 1050, and a communication interface 1070. The image sensor 1010, the memory 1030, the processor 1050, and the communication interface 1070 may be connected to each other via a communication bus 1005. The communication bus 1005, the image sensor 1010, the memory 1030, the processor 1050, and the communication interface 1070 may be included in an SoC. Some of the components of the image processing apparatus 1000 may be omitted or other components may be added thereto.

The image sensor 1010 may capture an input image including a first image frame corresponding to a first time point and a second image frame corresponding to a second time point.

The memory 1030 may store a neural network model. The neural network model may be, for example, an entropy coder for performing entropy coding and/or a neural encoder for performing compression encoding on image data, but embodiments are not limited thereto. The neural encoder may operate to be compatible with a standard video codec. A bitstream generated by the neural encoder may be interpreted by a decoder of a standard video codec or may be restored to an image by an arbitrary video decoder following the same standard. The neural encoder may train a neural network to process an output corresponding to each of a plurality of input frames by a standard decoder. The standard decoder may include, for example, high efficiency video coding (HEVC), but is not limited thereto. The neural encoder may train the neural network by, for example, unsupervised learning or self-supervised learning. The neural network may include a deep neural network. In addition, the neural network may include a convolutional neural network (CNN), a recurrent neural network (RNN), a perceptron, a multilayer perceptron, a feed forward (FF) network, a radial basis network (RBF), a deep feed forward (DFF) network, a long short-term memory (LSTM), a gated recurrent unit (GRU), an auto encoder (AE), a variational auto encoder (VAE), a denoising auto encoder (DAE), a sparse auto encoder (SAE), a Markov chain (MC), a Hopfield network (HN), a Boltzmann machine (BM), a restricted Boltzmann machine (RBM), a deep belief network (DBN), a deep convolutional network (DCN), a deconvolutional network (DN), a deep convolutional inverse graphics network (DCIGN), a generative adversarial network (GAN), a liquid state machine (LSM), an extreme learning machine (ELM), an echo state network (ESN), a deep residual network (DRN), a differentiable neural computer (DNC), a neural turning machine (NTM), a capsule network (CN), a Kohonen network (KN), a binarized neural network (BNN), a transformer, and an attention network (AN).

In addition, the memory 1030 may store instructions (or programs) executable by the processor 1050. For example, the instructions include instructions for performing an operation of the processor 1050 and/or an operation of each component of the processor 1050.

The memory 1030 may be implemented as a volatile memory device or a non-volatile memory device. The volatile memory device may be implemented as dynamic random-access memory (DRAM), static random-access memory (SRAM), thyristor RAM (T-RAM), zero capacitor RAM (Z-RAM), or twin transistor RAM (TTRAM). The non-volatile memory device may be implemented as electrically erasable programmable read-only memory (EEPROM), flash memory, magnetic RAM (MRAM), spin-transfer torque (STT)-MRAM, conductive bridging RAM (CBRAM), ferroelectric RAM (FeRAM), phase change RAM (PRAM), resistive RAM (RRAM), nanotube RRAM, polymer RAM (PoRAM), nano floating gate Memory (NFGM), holographic memory, a molecular electronic memory device, or insulator resistance change memory.

The processor 1050 may infer parameters by applying an input image to a neural network model. The parameters may indicate global motion information including a 3D motion of the input image and auxiliary information corresponding to at least one task using the global motion information.

In addition, the processor 1050 may perform at least one method described with reference to FIGS. 1 to 9 or an algorithm corresponding to the at least one method. The processor 1050 may be a hardware-implemented data processing device having a circuit that is physically structured to execute desired operations. For example, the desired operations may include code or instructions in a program. The processor 1050 may be implemented as, for example, a CPU, a GPU, or an NPU. The processor 1050 may include, for example, a microprocessor, a CPU, a processor core, a multi-core processor, a multiprocessor, an application-specific integrated circuit (ASIC), and a field-programmable gate array (FPGA).

The processor 1050 may execute a program and control an image processing apparatus 1000. Program codes to be executed by the processor 1050 may be stored in the memory 1030.

The communication interface 1070 may output the parameters inferred by the processor 1050. The communication interface 1070 may output the parameters indicating the global motion information and/or the auxiliary information to at least one of a codec, a video stabilizer, and an ISP.

The image processing apparatus 1000 may be implemented in a personal computer (PC), a cloud server, a data server, or a portable device. The portable device may be implemented as a laptop computer, a mobile phone, a smartphone, a tablet PC, a mobile internet device (MID), a personal digital assistant (PDA), an enterprise digital assistant (EDA), a digital still camera, a digital video camera, a portable multimedia player (PMP), a personal navigation device or portable navigation device (PND), a handheld game console, an e-book, and/or a smart device. The smart device may be implemented as a smartwatch, a smart band, smart glasses and/or a smart ring.

The embodiments described herein may be implemented using a hardware component, a software component and/or a combination thereof. The device, method, and components described herein may be implemented using general-purpose or special-purpose computers like any other devices, such as, for example, a processor, a controller and an arithmetic logic unit (ALU), a DSP, a microcomputer, an FPGA, a programmable logic unit (PLU), a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of the processing device is used as singular; however, one skilled in the art will appreciate that the processing device may include multiple processing elements and multiple types of processing elements. For example, the processing device may include a plurality of processors, or a single processor and a single controller. In addition, different processing configurations are possible, such as parallel processors.

The software may include a computer program, a piece of code, an instruction, or some combination thereof, to independently or collectively instruct or configure the processing device to operate as desired. Software and data may be embodied permanently or temporarily in any type of machine, component, physical or pseudo equipment, computer storage medium or device, or in a propagated signal wave capable of providing instructions or data to or being interpreted by the processing device. The software also may be distributed over network-coupled computer systems so that the software is stored and executed in a distributed fashion. The software and data may be stored by one or more non-transitory computer-readable recording mediums.

The methods according to the above-described example embodiments may be recorded in non-transitory computer-readable media including program instructions to implement various operations of the above-described example embodiments. The media may also include, alone or in combination with the program instructions, data files, data structures, and the like. The program instructions recorded on the media may be those specially designed and constructed for the purposes of example embodiments, or they may be of the kind well-known and available to those having skill in the computer software arts. Examples of non-transitory computer-readable media include magnetic media such as hard disks, floppy disks, and magnetic tape; optical media such as CD-ROM discs, DVDs, and/or Blue-ray discs; magneto-optical media such as optical discs; and hardware devices that are specially configured to store and perform program instructions, such as read-only memory (ROM), random access memory (RAM), flash memory (e.g., USB flash drives, memory cards, memory sticks, etc.), and the like. Examples of program instructions include both machine code, such as produced by a compiler, and files containing higher-level code that may be executed by the computer using an interpreter.

The above-described hardware devices may be configured to act as one or more software modules in order to perform the operations of the above-described examples, or vice versa.

As described above, although the embodiments have been described with reference to the limited drawings, a person skilled in the art may apply various technical modifications and variations based thereon. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. An image processing method comprising:
receiving an input image comprising a first image frame corresponding to a first time point and a second image frame corresponding to a second time point;
inferring a plurality of parameters by applying the input image to a neural network model, wherein the plurality of parameters indicate global motion information comprising a three-dimensional (3D) motion of the input image and auxiliary information corresponding to at least one task using the global motion information; and
outputting the plurality of parameters.

2. The image processing method of claim 1, wherein the auxiliary information comprises information about at least one of scene change detection, inter-frame prediction confidence, and skip decision.

3. The image processing method of claim 1, wherein the plurality of parameters comprise a roll angle parameter, a pitch angle parameter, and a yaw angle parameter.

4. The image processing method of claim 1, wherein the plurality of parameters comprise at least one of a translation parameter, a rotation parameter, a scale parameter, and a shear parameter.

5. The image processing method of claim 1, further comprising:
generating a geometric transformation matrix by combining the plurality of parameters,
wherein the geometric transformation matrix comprises one of an affine transformation matrix and a homography transformation matrix.

6. The image processing method of claim 1, wherein the auxiliary information is identified by an element number or an index of an output channel corresponding to each task of the at least one task.

7. The image processing method of claim 1, wherein the neural network model is trained based on a first loss and a second loss,
wherein the first loss is determined based on a first label and first global motion information inferred by applying the input image to the neural network model, and
wherein the second loss is determined based on a second label and second auxiliary information inferred by applying, to the neural network model, an auxiliary image comprising a first auxiliary image frame corresponding to the first time point and a second auxiliary image frame corresponding to the second time point, and
wherein the input image is extracted from a first database, and the auxiliary image is extracted from a second database.

8. The image processing method of claim 1, further comprising:
generating an output image by encoding the first image frame and the second image frame using the plurality of parameters.

9. The image processing method of claim 8, wherein the output image is generated by driving one of a codec, a video stabilizer, and an image signal processor (ISP) using the plurality of parameters.

10. A learning method comprising:
inferring a plurality of first parameters by applying an input image extracted from a first database to a neural network model, wherein the input image comprises a first image frame corresponding to a first time point and a second image frame corresponding to a second time point, and wherein the plurality of first parameters comprise first global motion information and first auxiliary information corresponding to the input image;
calculating a first loss based on the first global motion information and a first label associated with the plurality of first parameters;
inferring a plurality of second parameters by applying, to the neural network model, an auxiliary image extracted from a second database, wherein the auxiliary image comprises a first auxiliary image frame corresponding to the first time point and a second auxiliary image frame corresponding to the second time point, and wherein the plurality of second parameters comprise second global motion information and second auxiliary information;
calculating a second loss based on a second label and the second auxiliary information; and
training the neural network model based on the first loss and the second loss.

11. The learning method of claim 10, wherein the inferring of the plurality of first parameters comprises inferring a plurality of normalized first parameters that normalize the first global motion information in a predetermined range, and
wherein the calculating of the first loss comprises:
denormalizing the plurality of normalized first parameters; and
calculating the first loss between the denormalized plurality of first parameters and a label corresponding to the first global motion information.

12. The learning method of claim 10, wherein the first loss comprises at least one from among:
a mean squared error (MSE) comprising an average value of a square of a difference between the first global motion information and the first label; and
a mean absolute error (MAE) comprising an average value of a difference between the first global motion information and the first label.

13. The learning method of claim 10, wherein the second loss comprises a binary cross entropy (BCE) comprising a value that probabilistically indicates a proximity of the second auxiliary information to the second label.

14. The learning method of claim 10, wherein the first label comprises a soft label expressed by a probability between a value of zero (“0”) and a value of one (“1”), and wherein the second label comprises a hard label expressed as the value of zero (“0”) or the value of one (“1”).

15. The learning method of claim 10, wherein the training of the neural network model based on the first loss and the second loss comprises:
training the neural network model by adjusting a reflection ratio between the first loss and the second loss.

16. A non-transitory computer-readable storage medium storing instructions which, when executed by a processor, cause the processor to:
receive an input image comprising a first image frame corresponding to a first time point and a second image frame corresponding to a second time point;
infer a plurality of parameters by applying the input image to a neural network model, wherein the plurality of parameters indicate global motion information comprising a three-dimensional (3D) motion of the input image and auxiliary information corresponding to at least one task using the global motion information; and
output the plurality of parameters.

17. An image processing apparatus comprising:
an image sensor configured to capture an input image comprising a first image frame corresponding to a first time point and a second image frame corresponding to a second time point;
a memory configured to store a neural network model;
a processor configured to:
infer a plurality of parameters by applying the input image to the neural network model, wherein the plurality of parameters indicate global motion information comprising a three-dimensional (3D) motion of the input image, and auxiliary information corresponding to at least one task using the global motion information, and
generate a geometric transformation matrix by combining the plurality of parameters; and
a communication interface configured to output the geometric transformation matrix.

18. The image processing apparatus of claim 17, wherein the auxiliary information comprises information about at least one of scene change detection, inter-frame prediction confidence, and skip mode decision.

19. The image processing apparatus of claim 17, wherein the plurality of parameters comprise at least one of:
a roll angle parameter, a pitch angle parameter, and a yaw angle parameter, a translation parameter, a rotation parameter, a scale parameter, and a shear parameter.

20. The image processing apparatus of claim 17, wherein the auxiliary information is identified by an element number or an index of an output channel corresponding to each task of the at least one task.
